(19) United States
(12) Patent Application Publication
(10) Pub. No.: US 2013/0294306 A1
(43) Pub. Date: Nov. 7, 2013

(54) NETWORK ACCESS USING SHORT-RANGE CONNECTABILITY

(71) Applicant: APPLE INC., Cupertino, CA (US)

(72) Inventors: Daniel Borges, San Francisco, CA (US); Michael Jason Giles, San Jose, CA (US); Michael Larson, San Jose, CA (US)

(73) Assignee: APPLE INC., Cupertino, CA (US)

(21) Appl. No.: 13/800,126

(22) Filed: Mar. 13, 2013

Related U.S. Application Data
(60) Provisional application No. 61/641,255, filed on May 1, 2012.

(51) Int. Cl. H04W 76/02; H04W 52/02

(52) U.S. Cl. CPC H04W 76/02; H04W 52/0212
USPC 370/311; 370/338

(57) ABSTRACT

A device accesses a remote network using short-range connectability with another device providing shared access to the remote network.

### CROSS-REFERENCE TO RELATED APPLICATIONS

This application claims the benefit of a provisional application, Application Ser. No. 61/641,255, entitled NETWORK ACCESS USING SHORT-RANGE CONNECTABILITY, filed on May 1, 2012.

### TECHNICAL FIELD

The technical field relates generally to the network communications, and in particular wireless network communications.

### SUMMARY OF THE DESCRIPTION

Methods, machine readable tangible storage media, and data processing systems that enable network access using short-range connectability are described.

A device accesses a network using short-range connectability to a supporting device that provides shared access to the network. In one embodiment, the device and supporting device are paired together using a proximity profile of a short-range connection protocol in which the devices trigger a proximity notification alert when within range of each other.

In one embodiment, the proximity profile defines a proximity notification alert that the supporting device sends to the device to advertise its shared access service to the network for devices within range. In one embodiment, upon receiving the proximity notification alert the device joins the supporting device's shared access service and briefly connects to the network to receive push notifications or other messages, before disconnecting. The supporting device then disables the shared access service until the next time the devices are within range and the process repeats.

In one embodiment, the short-range connectability to the supporting device is provided over a low-power enabled connection protocol such as Bluetooth. In a typical embodiment, the device is able to maintain itself in a low-power background mode while joining the supporting device's shared access service and briefly connecting to the network. In this manner the device may perform such activities as establishing intermittent network presence for receiving push notifications and other messages or updates, or for engaging in other network-related activities while advantageously remaining in low power mode.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating network access using short-range connectability in accordance with an embodiment of the present invention;

FIG. 2 is a sequence diagram illustrating illustrating network access using short-range connectability in accordance with an embodiment of the present invention;

FIGS. 3A-3B are flow diagrams illustrating network access using short-range connectability in accordance with an embodiment of the present invention; and

FIG. 4 illustrates an example of a typical computer system which may be used in conjunction with the embodiments described herein.

### DETAILED DESCRIPTION

Methods and apparatuses for enabling network access using short-range connectability are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g. circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

As devices become more network-reliant for the latest updates to email, news, and other applications running on those devices, getting timely access to the network is becoming more critical. Radio-enabled devices provide an alternate way to access the network when users are on the go, but obviously not all devices are equipped with radios. Using short-range connectability, devices without radios can be paired with radio-enabled devices to automatically establish a brief intermittent connection with the network that will allow the device to perform such tasks as establishing network presence for receiving push notifications and other types of messages or updates. In this manner, users can leverage their mobile radio communication devices, such as their cell phones, to provide network access to their other devices without having to manually enable such connections. In turn, the other devices can benefit from the network access while remaining in low-power mode during a short-range connection that uses a low-power enabled connection.

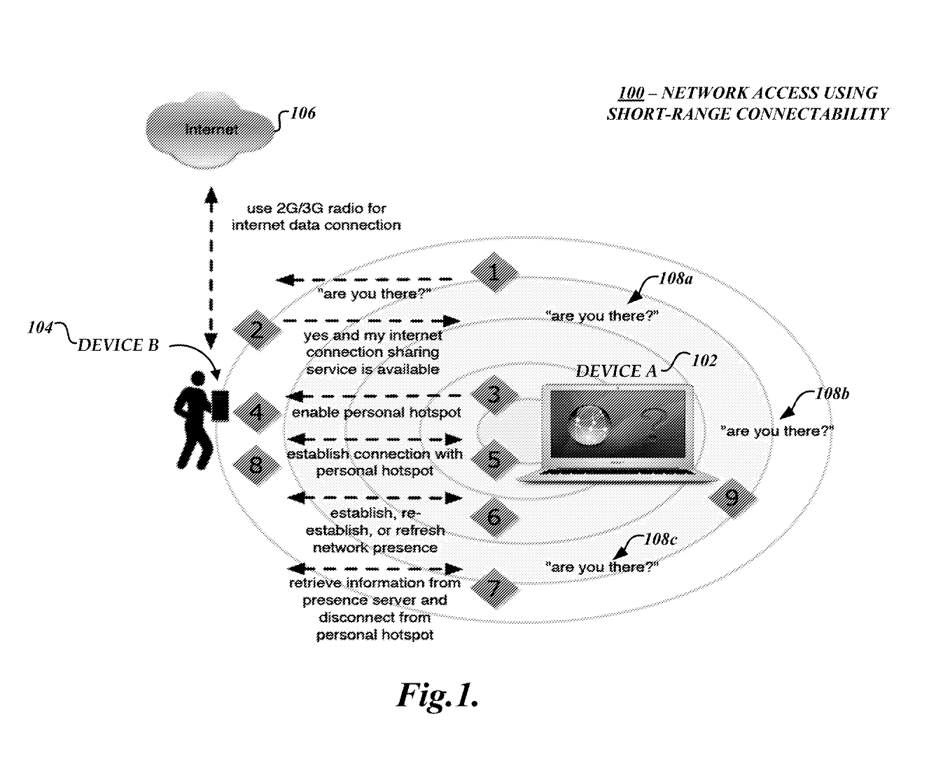

FIG. 1 illustrates an example overview 100 of providing network access using short-range connectability. A device, Device A 102, which may be any device capable of establishing a connection with a remote network, such as the Internet, has been paired with a second supporting device, Device B 104, which is typically a device such as a mobile telephone, that is capable of providing shared access to the network via its radio capability, such as a 2G/3G radio. The pairing of the two devices occurs over a short-range connection between them, as would typically be provided by a Bluetooth enabled connection. During pairing a proximity profile is pre-defined between the devices which allows the supporting device to advertise the shared access service and allows the device to request that the shared access service be activated and to join the shared access service while the devices are within range.

In a typical embodiment, the process of providing network access using short-range connectability follows several steps, illustrated in FIG. 1 as steps 1 through step 9. As illustrated, in step 1, Device A 102, the device seeking alternative ways of accessing the network (other than through its own WiFi or local area network (LAN) connection), can scan over its low-power connection (e.g. Bluetooth) for other devices within its proximity, i.e. within range. In step 2, Device B 104 responds to Device A's scan with a proximity notification alert advertising the shared network access service. In step 3, Device A requests that the shared network access service be activated. In a typical embodiment, once the shared network access service is activated, Device A requests to join the service via a personal hotspot set up by Device B in step 4.

In one embodiment, in steps 5-7, Device A connects to Device B's personal hotspot and is able to access the remote network and transact any business, such as establishing, re-establishing or refreshing network presence with a preconfigured presence server accessible via the remote network, or receiving notifications or other updates from other application servers via the remote network. A typical example would be receiving updates from a cloud network application, such as the iCloud® service of the Apple Corporation. Other application servers might include updates from iTunes®, App updates from the App Store, calendar updates, email message updates, downloads of podcasts, Find my Mac updates, etc.

Since the connection is intended to be brief, once these tasks are completed, the connection is ended and Device A disconnects from Device B's personal hotspot. Although a longer connection could be established, as a practical matter the duration of the connection and the amount of messaging exchanged between Device A and the remote network are limited by the battery power of Device B and the data rates charged for sending data over the radio connection, not to mention the necessity of Device A and Device B remaining in sufficient proximity to one another to stay connected. Thus, in a typical embodiment, step 8 is Device B disabling the personal hotspot and shared network access, and step 9 is Device A returning to sleep mode, and scanning again for future opportunities to establish a connection.

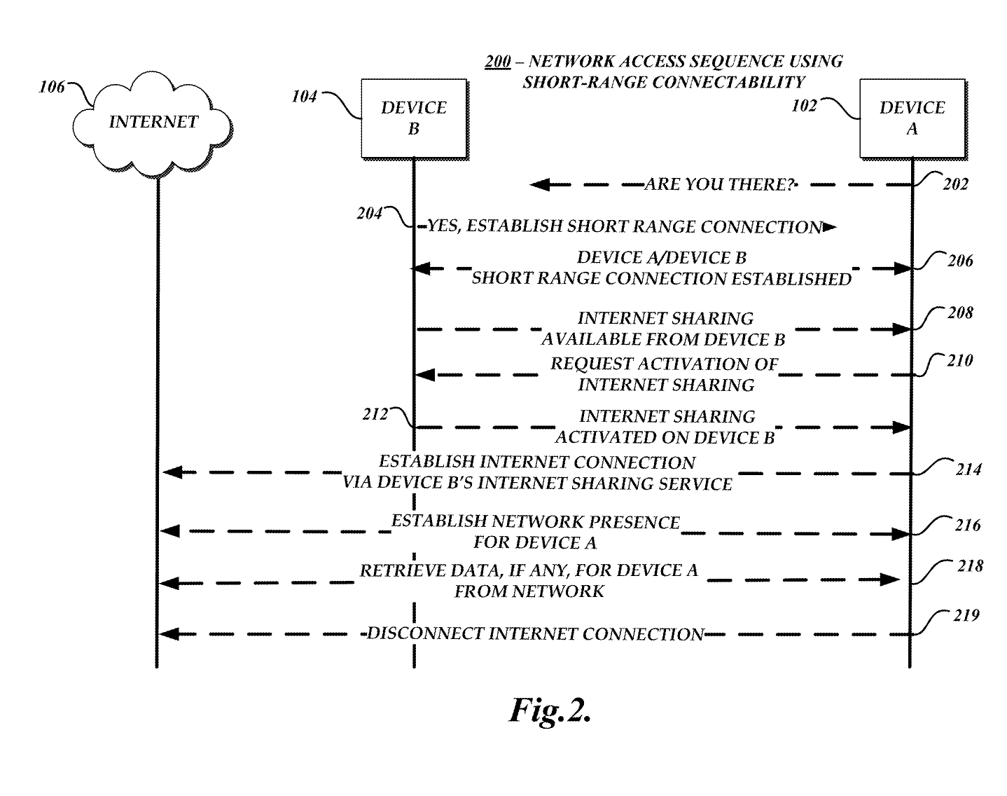

FIG. 2 is a sequence diagram that illustrates network access using short range connectability in accordance with an embodiment of the present invention. As in FIG. 1, Device A 102 comes into proximity with a supporting device, Device B 104, triggering a sequence of events as will be described in further detail that allow Device A to access the internet 106 via an internet sharing service offered by Device B.

In one embodiment, the sequence of events begins with Device A issuing short range scanning requests 202 “are you there?” to determine if there are any other devices within range and with which it can establish a short range connection. Device B is within range and responds 204 to the scanning request “yes, let's establish a connection.” Subsequently, and Devices A and B establish a short range connection 206 with one another.

Once the short range connection is established, Device B notifies any device to which it is connected, such as Device A, of the availability of an internet sharing service via the connection with Device B 208. Device A acknowledges receipt of the notification and requests activation of internet sharing 210. Device B responds by activating internet sharing and notifying Device A 212.

Once the internet sharing service has been activated on Device B, then Device A requests an internet connection via Device B's internet sharing service 214. Once the internet connection has been made, then Device A can interact via the internet connection to establish Device A's network presence 216. After successfully establishing a network presence, Device A is able to retrieve data, if any, from the network via the internet connection 218. When no longer needed, Device A can request disconnection from the internet 219 or, alternatively, the disconnection may be triggered by termination of the internet connection for other reasons and/or the unavailability of the internet sharing service. For example, should Device A and Device B fail to remain in sufficient proximity for maintaining the short-range connection, then the internet sharing service is no longer available and disconnection is triggered.

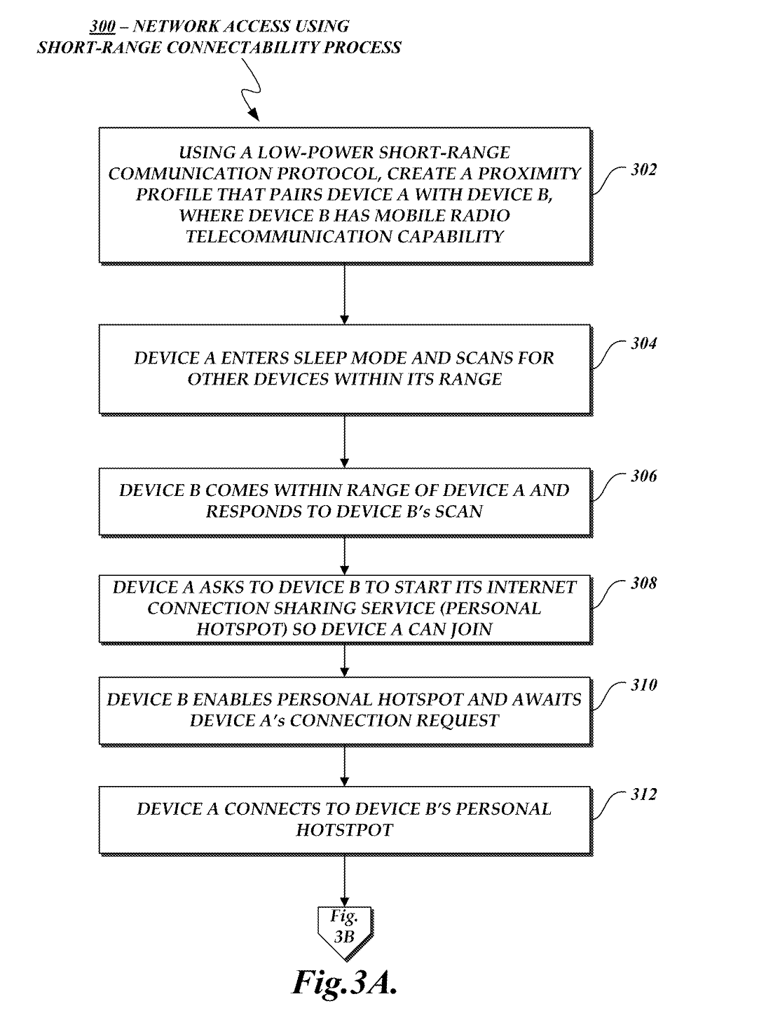

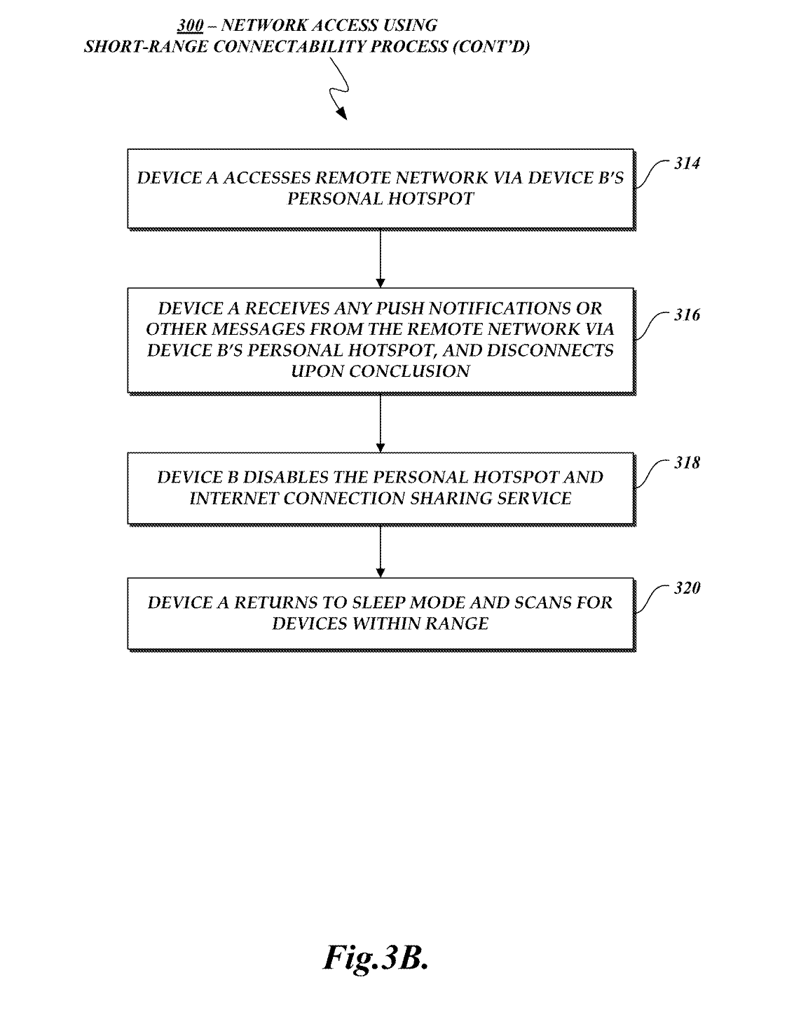

FIGS. 3A and 3B are flow diagrams illustrating embodiments of a process 300 for network access using short-range connectability in further detail. The process 300 begins at 302 by creating a proximity profile that pairs Device A with Device B where Device B has mobile radio telecommunication capability. At process 304, Device A enters sleep mode and scans for other devices within its range. At process 306, Device B comes within range of Device A and responds to Device B's scan. At process 308, Device A asks Device B to start its network sharing service and to create a personal hotspot so that Device A can join. At process 310, Device B enables the personal hotspot and awaits Device A's connection request. At process 312. Device A finally connects to Device B's personal hotspot.

In one embodiment, at process 314, Device A accesses a remote network via Device B's personal hotspot, and proceeds at 316 to, for example, receive push notifications or other messages from the remote network. In one embodiment, Device A may remain in a low-power mode while conducting the tasks related to accessing the remote network via Device B's personal hotspot. Upon concluding with the access to the remote network, Device A disconnects from the personal hotspot. At process 318, Device B disables the personal hotspot when it is no longer needed, and disables access to the remote network. Finally, at process 320, Device A returns to a low-power mode, such as sleep mode, and resumes scanning for future opportunities to connect.

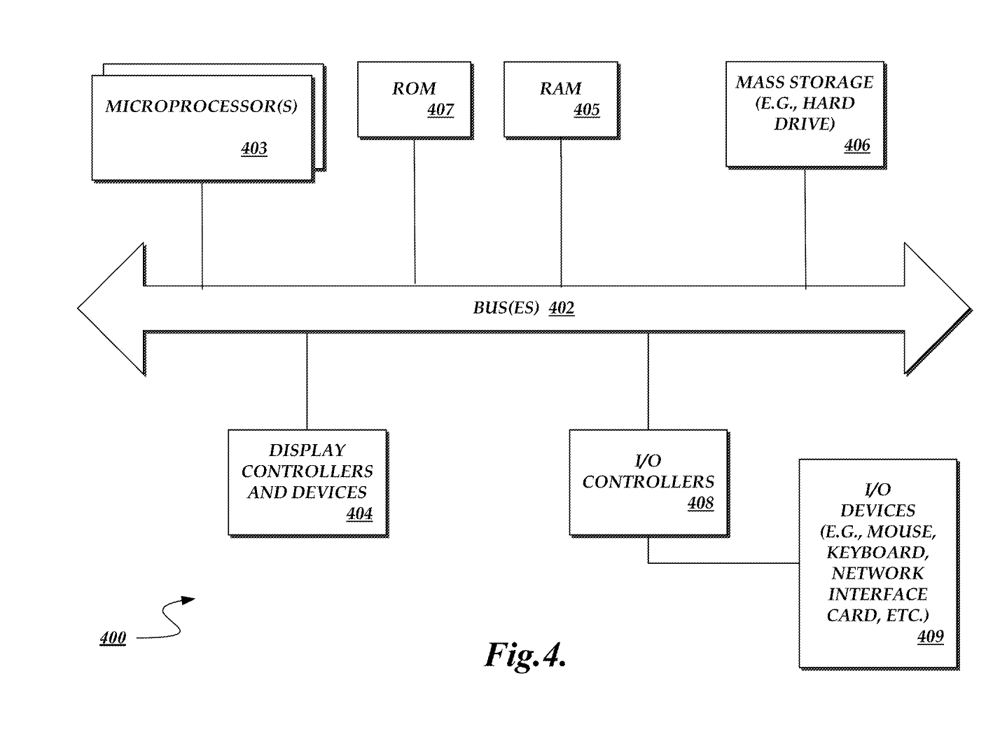

FIG. 4 shows one example of a typical data processing system which may be used with the present invention. Note that while FIG. 4 illustrates the various components of a data processing system, such as a computer system, it is not intended to represent any particular architecture or manner of interconnecting the components as such details are not germane to the present invention. It will also be appreciated that other types of data processing systems which have fewer components than shown or more components than shown in FIG. 4 may also be used with the present invention. The data processing system of FIG. 4 may be a Macintosh computer from Apple Inc. of Cupertino, Calif., or a mobile computer system such as that employed on mobile devices such as an iPhone from Apple Inc. As shown in FIG. 4, the data processing system 401 includes one or more buses 409 which serve to interconnect the various components of the system. One or more processors 403 are coupled to the one or more buses 409 as is known in the art. Memory 405 may be DRAM or non-volatile RAM or may be flash memory or other types of memory. This memory is coupled to the one or more buses 409 using techniques known in the art. The data processing system 401 can also include non-volatile memory 407 which may be a hard disk drive or a flash memory or a magnetic optical drive or magnetic memory or an optical drive or other types of memory systems which maintain data even after power is removed from the system. The non-volatile memory 407 and the memory 405 are both coupled to the one or more buses 409 using known interfaces and connection techniques. A display controller 411 is coupled to the one or more buses 409 in order to receive display data to be displayed on a display device 413 which can display any one of the user interface features or embodiments described herein. The display device 413 can include an integrated touch input to provide a touch screen. The data processing system 401 can also include one or more input/output (I/O) controllers 415 which provide interfaces for one or more I/O devices, such as one or more mice, touch screens, touch pads, joysticks, and other input devices including those known in the art and output devices (e.g. speakers). The input/output devices 417 are coupled through one or more I/O controllers 415 as is known in the art. While FIG. 4 shows that the non-volatile memory 407 and the memory 405 are coupled to the one or more buses directly rather than through a network interface, it will be appreciated that the data processing system may utilize a non-volatile memory which is remote from the system, such as a network storage device which is coupled to the data processing system through a network interface such as a modem or Ethernet interface or wireless interface, such as a wireless WiFi transceiver or a wireless cellular telephone transceiver or a combination of such transceivers. As is known in the art, the one or more buses 409 may include one or more bridges or controllers or adapters to interconnect between various buses. In one embodiment, the I/O controller 415 includes a USB adapter for controlling USB peripherals and can control an Ethernet port or a wireless transceiver or combination of wireless transceivers. It will be apparent from this description that aspects of the present invention may be embodied, at least in part, in software. That is, the techniques and methods described herein may be carried out in a data processing system in response to its processor executing a sequence of instructions contained in a tangible, non-transitory memory such as the memory 405 or the non-volatile memory 407 or a combination of such memories, and each of these memories is a form of a machine readable, tangible storage medium. In various embodiments, hardwired circuitry may be used in combination with software instructions to implement the present invention. Thus the techniques are not limited to any specific combination of hardware circuitry and software or to any particular source for the instructions executed by the data processing system.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g. an abstract execution environment such as a “virtual machine” (e.g. a Java Virtual Machine), an interpreter, a Common Language Runtime, a high-level language virtual machine, etc.), and/or, electronic circuitry disposed on a semiconductor chip (e.g. “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g. one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g. a server) to a requesting computer (e.g. a client) by way of data signals embodied in a propagation medium (e.g. via a communication link (e.g. a network connection)).

The term “memory” as used herein is intended to encompass all volatile storage media, such as dynamic random access memory (DRAM) and static RAM (SRAM). Computer-executable instructions can be stored on non-volatile storage devices, such as magnetic hard disk, an optical disk, and are typically written, by a direct memory access process, into memory during execution of software by a processor. One of skill in the art will immediately recognize that the term “machine-readable storage medium” includes any type of volatile or non-volatile storage device that is accessible by a processor.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine-implemented method for accessing a remote network, the method comprising:
for a first device having short-range connectability with a second device, the second device having access to remote networks, performing in the first device:
establishing a short-range connection between the first device and the second device when the first and second devices are within range of each other;
receiving a notification that the second device offers a service for sharing access to remote networks;
responsive to receiving the notification, joining the service;
accessing a remote network via the service; and
establishing a network presence with an application server in communication with the remote network.

2. A machine-implemented method as in claim 1, wherein the service for accessing remote networks is a personal hotspot enabled on the second device, the personal hotspot supporting shared access to remote networks via mobile radio telecommunication.

3. A machine-implemented method as in claim 2, wherein the personal hotspot enabled on the second device is available to the first device via the short-range connection established between the first and second devices.

4. A machine-implemented method as in claim 2, wherein the personal hotspot enabled on the second device is available to the first device via a wireless local area network to which the first and second devices are both connected.

5. A machine-implemented method as in claim 1, wherein the short-range connectability is supported with a proximity network protocol, the method further comprising in the first device:
pairing the first device with the second device using the proximity network protocol, wherein pairing the first device with the second devices causes the second device to send notifications to the first device when the devices are within range of each other, including the notification that the second device offers the service for sharing access to remote networks.

6. A machine-implemented method as in claim 5, wherein the notification that the second device offers the service for sharing access to remote networks is defined using the proximity network protocol.

7. A machine-implemented method as in claim 5, wherein the proximity network protocol is a low-power connection protocol that enables the first and second devices to remain in low-power mode during the short-range connection.

8. A machine-implemented method as in claim 1, wherein the application server on the remote network is a presence server, and establishing a network presence includes exchanging messages with the presence server, including messages to establish, re-establish, or refresh the network presence.

9. A machine-implemented method as in claim 1, the method further comprising performing in the first device:
scanning for devices within range of the first device, wherein the short-range connection between the first device and the second device is established in response to scanning the second device.

10. A data processing system for accessing a remote network, the system comprising:
a first and second device capable of having a wireless short-range connection with one another when the devices are within range;
the second device having radio-enabled access to remote networks, the second device capable of sharing with other devices the radio-enabled access to remote networks;
preconfiguring the first and second devices to:
establish the wireless short-range connection with one another when the devices are within range;
preconfiguring the first device to:
issue a request to the second device to activate sharing with other devices the radio-enabled access to remote networks,
access a remote network via the activated shared radio-enabled access to remote networks, and
establish network presence in an application server in communication with the remote network; and
preconfiguring the second device to:
notify the first device about the capability of sharing with other devices the radio-enabled access to remote networks, and
activate sharing with other devices the radio-enabled access to remote networks responsive to the request issued by the first device.

11. A data processing system as in claim 10, wherein the second device is capable of sharing with other devices the radio-enabled access to remote networks using a personal hotspot enabled on the second device, the personal hotspot supporting shared access to remote networks via mobile radio telecommunication.

12. A data processing system as in claim 11, wherein the personal hotspot enabled on the second device is available to the first device via the short-range connection established between the first and second devices.

13. A data processing system as in claim 11, wherein the personal hotspot enabled on the second device is available to the first device via a wireless local area network to which the first and second devices are both connected.

14. A data processing system as in claim 10, wherein the wireless short-range connection is supported with a proximity network protocol, wherein preconfiguring the first and second devices to establish the wireless short-range connection with one another when the devices are within range includes pairing the first device with the second device using the proximity network protocol, wherein pairing the first device with the second device causes the second device to notify the first device when the devices are within range of each other and about the capability of sharing with other devices the radio-enabled access to remote networks.

15. A data processing system as in claim 14, wherein the proximity network protocol is a low-power connection protocol that enables the first and second devices to remain in low-power mode during the wireless short-range connection.

16. A non-transitory computer-readable medium containing instructions that, when executed on a device, facilitate accessing a remote network, the instructions comprising in a first device:
establishing a short-range connection between the first device and a second device, the first and second devices having short-range connectability when they are within range of each other;
receiving a notification that the second device offers a service for sharing access to remote networks;
responsive to receiving the notification, joining the service;
accessing a remote network via the service; and
establishing a network presence with an application server in communication with the remote network.

17. A non-transitory computer-readable medium as in claim 16, wherein the service for accessing remote networks is a personal hotspot enabled on the second device, the personal hotspot supporting shared access to remote networks via mobile radio telecommunication.

18. A non-transitory computer-readable medium as in claim 17, wherein the personal hotspot enabled on the second device is available to the first device via the short-range connection established between the first and second devices.

19. A non-transitory computer-readable medium as in claim 17, wherein the personal hotspot enabled on the second device is available to the first device via a wireless local area network to which the first and second devices are both connected.

20. A non-transitory computer-readable medium as in claim 16, wherein the short-range connectability is supported with a proximity network protocol enabling the devices to remain in low-power mode during the short-range connection, the instructions comprising, in the first device:
pairing the first device with the second device using the proximity network protocol, wherein pairing the first device with the second devices causes the second device to send notifications to the first device when the devices are within range of each other, including the notification that the second device offers the service for sharing access to remote networks.
